(19) United States
(12) Patent Application Publication
(10) Pub. No.: US 2008/0008469 A1
(43) Pub. Date: Jan. 10, 2008

(54) Communication apparatus, communication line diagnosis method, program and recording medium

(75) Inventor: Yoshitaka Yokoyama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/812,961

(22) Filed: Jun. 22, 2007

(30) Foreign Application Priority Data
Jun. 23, 2006 (JP) 174409/2006

(51) Int. Cl. H04B 10/08; H04J 14/00

(52) U.S. Cl. 398/16; 714/25; 398/27

(57) ABSTRACT

In a communication apparatus and the like, the line diagnosis using a test signal is conducted with higher precision. A test signal transmitter generates a test signal for a line diagnosis to feed the signal to a test signal multiplexer. The multiplexer multiplexes the test signal with a main signal to deliver the resultant signal to a clock and data regenerator (CDR) module, a main signal transmitter, a main signal receiver, a test signal separator, and a test signal receiver that are arranged on a communication line through which the main signal is transferred. In the operation, a controller accomplishes a control operation such that the bit rate of the test signal is more than that of signals for communication to thereby intentionally cause bit errors. This improves precision in the measurement of the bit error rate required for the line diagnosis.

This application is based upon and claims the benefit of priority from Japanese patent application No. 2006-174409, filed on Jun. 23, 2006, the disclosure of which is incorporated herein in its entirety by reference.

### BACKGROUND OF THE INVENTION

1. Field of the Invention

The present invention pertains to a communication line diagnosis method for a communication apparatus or the like, and in particular, to a method of diagnosing a communication line independently of a protocol.

2. Description of the Related Art

To examine quality of a communication line, it has been a common practice to use a test signal and conduct a line diagnosis of the communication line. In a line diagnosis method, for example, a test signal is delivered to the communication apparatus to cause a bit error. By measuring the bit error, quality of the communication line is quantitatively evaluated. In general, the line speed or the bit rate of the test signal used for the diagnosis is set to a value substantially equivalent to that of signals communicated in ordinary communication.

As a result of recent improvement of technologies and techniques, the occurrence of bit errors is reduced to improve the line quality and hence the transmission distance is tremendously elongated. However, due to the improvement in the line quality, it is difficult to carry out the line diagnosis for the following reason. To measure the bit error rate, it is necessary that bit errors occur at a fixed rate. Since the bit errors are suppressed, sample data cannot be easily gathered. It is no exaggeration to say that the bit error hardly occurs particularly in an optical communication apparatus that conducts communication using optical signals. This makes the line diagnosis more difficult.

In order for bit errors to occur, the bit rate of signals is increased and the line quality lowered. Therefore, by using a higher bit rate for the test signal to cause bit errors, it is theoretically possible to desirably collect sample data for the diagnosis. However, the communication apparatus is not designed to allow a higher bit rate of the test signal. This is because the bit rate of signals for communication is substantially set to the maximum bit rate that can be achieved under the hardware performance of the communication apparatus. As far as the bit rate of the test signal is as high as that of signals in the ordinary communication, the bit rate of the test signal is the maximum bit rate achieved by the hardware performance of the apparatus. If it is desired to set the bit rate to a higher value, the hardware performance must be improved. However, if the hardware is redesigned to improve the performance, the object of diagnosis, the original communication apparatus, is completely changed and the diagnosis for such communication apparatus then becomes meaningless.

Japanese Patent Application Laid-Open No. 2003-188828 (document 1) entitled “an optical transmission system and an optical channel stable quality measuring method” describes a technique for determining a state of an optical fiber transmission path as a test target by use of a judge criterion of a bit error rate. However, according to document 1, repetitive signals having a bit rate less than that of input data signals are adopted as test signals. It is therefore difficult even for those skilled in the art to think of an idea of causing bit errors by increasing the bit rate of the test signals at the designing of the communication apparatus.

### SUMMARY OF THE INVENTION

Disclosed herein are a communication apparatus, method, program to improve precision of the line diagnosis using a test signal.

A communication apparatus according to an exemplary aspect of the invention includes a module that generates a test signal to be used for a line diagnosis. The apparatus conducts a line diagnosis with the test signal having a bit rate more than a bit rate of a signal employed for communication.

A line diagnosis method according to an exemplary aspect of the invention includes a step of conducting a line diagnosis in which a test signal adopted for a line diagnosis has a line bit rate more than a bit rate of a signal employed for communication.

A computer program product according to an exemplary aspect of the invention, when executed, causes a computer to perform the following: generating a test signal to be used for a line diagnosis and conduct a line diagnosis with the test signal having a bit rate more than a bit rate of a signal for communication.

A recording medium according to an exemplary aspect of the invention may store the program therein.

### BRIEF DESCRIPTION OF THE DRAWINGS

Features of the disclosed embodiments will be described by way of the following detailed description with reference to the accompanying drawings in which:

FIG. 1 is a schematic block diagram showing a configuration of a communication apparatus;

FIG. 2 is a flowchart showing operation of the line diagnosis;

FIG. 3 is a graph showing an example of results of the line diagnosis;

FIG. 4 is a graph showing an example of results of the line diagnosis;

FIG. 5 is a flowchart showing operation of the line diagnosis of a communication apparatus;

FIG. 6 is a graph conceptually showing dependence of the bit error rate on the bit rate;

FIG. 7 is a block diagram showing a configuration of a communication apparatus 100 including transceivers 110;

FIG. 8 is a block diagram showing a configuration of a communication apparatus 100 including transceivers that share test signal transmitters and test signal receivers associated with main signal lines; and

FIG. 9 is a block diagram showing structure of an optical network system including communication apparatuses.

### DESCRIPTION OF EXEMPLARY EMBODIMENTS

Referring next to the accompanying drawings, description will be given of exemplary embodiments of a communication apparatus.

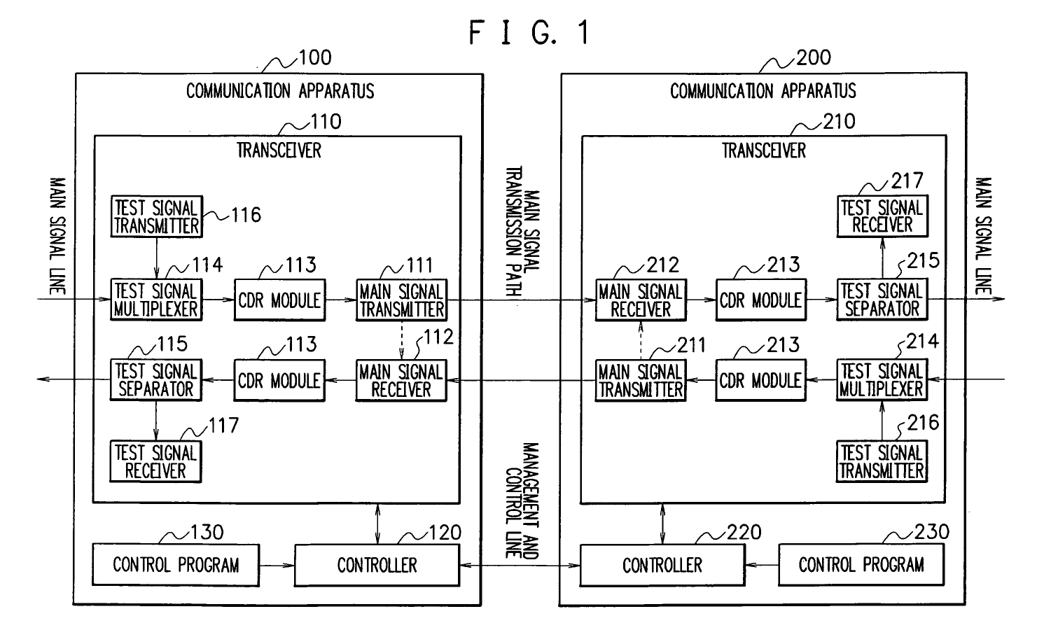

FIG. 1 shows, in a block diagram, a configuration of a communication apparatus 100 and a communication apparatus 200. The communication apparatus 100 includes a transceiver 110, a controller 120 including a Central Processing Unit (CPU) to supervise operation of the transceiver 110 in a centralized manner, and a control program 130 in the form of a recording medium, a Read Only Memory (ROM), having stored programs that are read out for the controller 120 to control the transceiver 110 and the other constituent components. The transceiver 110 includes a main signal transmitter 111 that feeds a main signal used for communication to the communication apparatus 200 at a desired bit rate, a main signal receiver 112 that receives the main signal from the apparatus 200 at a desired bit rate, a clock and data regenerator circuit (CDR module) 113 that extracts a clock signal by itself for synchronization with the main signal, a test signal multiplexer 114 that multiplexes a text signal with the main signal, a test signal demultiplexing or separating module 115 that separates the test signal that has been multiplexed with the main signal, a test signal transmitter 116 that generates and delivers a test signal to the test signal multiplexer 114, and a test signal receiver 117 that receives the test signal separated by the test signal separator 115.

The communication apparatus 200 includes a transceiver 210, a controller 220 including a CPU to control operation of the transceiver 210 in a centralized way, and a control program 230 in the form of a recording medium, namely, a ROM having stored programs that are read out for the controller 120 to supervise the transceiver 210 and the other constituent components. The transceiver 210 includes a main signal transmitter 211 that feeds a main signal for communication to the communication apparatus 100 at a desired bit rate, a main signal receiver 212 that receives the main signal from the apparatus 200 at a desired bit rate, a CDR module 213 that extracts a clock signal by itself for synchronization with the main signal, a test signal multiplexer 214 that multiplexes a text signal with the main signal, a test signal separator module 215 that separates the test signal that has been multiplexed with the main signal, a test signal transmitter 216 that generates and delivers a test signal to the test signal multiplexer 214, and a test signal receiver 217 that receives the test signal separated by the test signal separator 215. The main signal transmitter 111 and the main signal receiver 112 of the communication apparatus 100 are respectively coupled via main signal transmission paths respectively with the main signal receiver 212 and the main signal transmitter 211 of the communication apparatus 200. The controller 120 of the communication apparatus 100 is linked via a management and communication line with the controller 220 of the communication apparatus 200.

Main signal lines in device are connected, for example, to protocol-dependent modules, not shown, of the communication apparatuses 100 and 200 such that signals encoded according to a predetermined transmission protocol are fed to the test signal multiplexers 114 and 214.

When the apparatus 100 does not conduct the line diagnosis, the multiplexer 114 passes the signal received via the main signal line directly to a CDR module 113. The CDR module 113 that conducts re-timing by use of a clock signal extracted by itself regenerates the signal. The signal is delivered via the main signal transmitter 111 to the main signal transmission path and is then fed to the communication apparatus 200. The signal is received by the main signal receiver 212 to be regenerated by the CDR module 213 and is transferred via the test signal separator 215 to the main signal line in device.

When the apparatus 100 carries out the line diagnosis, a test signal produced from the test signal transmitter 116 is sent via the test signal multiplexer 114 and the CDR module 113 to the main signal transmitter 111. In this operation, the main signal transmission path is disconnected, and hence the signal is fed to the main signal receiver 112. To receive a test signal in the communication apparatus 100, the test signal is transferred through the main signal receiver 112 and a CDR module 113 to the test signal separator 115. The signal is then delivered to the test signal receiver 117. The controllers 120 and 220 respectively conduct centralized control operations to set operation bit rates respectively to the test signal transmitters 116 and 216, the test signal receivers 117 and 217, the test signal multiplexers 114 and 214, the test signal separators 115 and 215, and the CDR modules 113 and 213. Communication of signals between the apparatuses 100 and 200 is accomplished via the management and control communication line. This line is employed to communicate control signals for the line diagnosis.

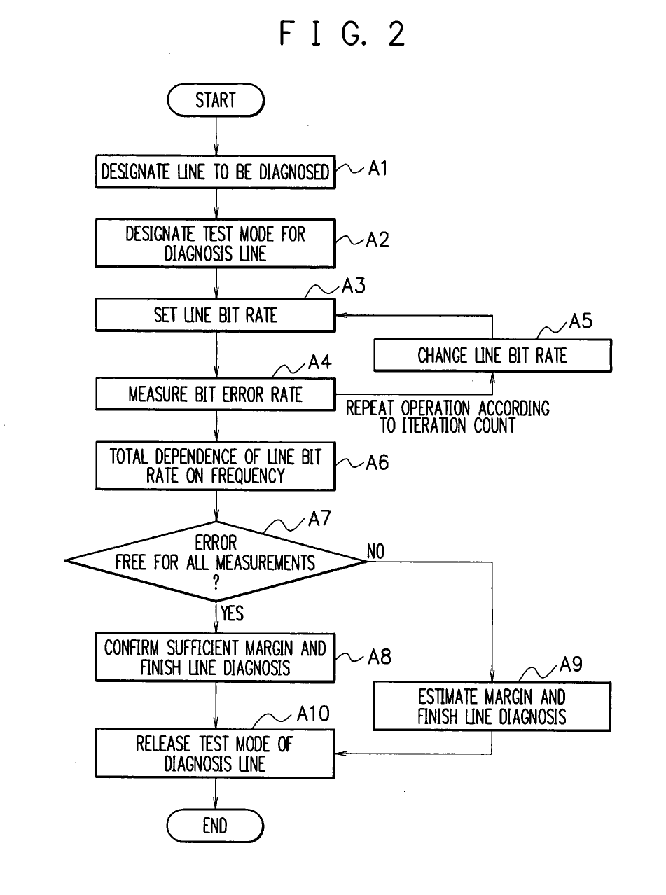

Description will now be given of operation for the line diagnosis method adopted by the communication apparatus 100. FIG. 2 is a flowchart of operation for the diagnosis.

First, a line to be diagnosed by the apparatus 100 is designated (step A1). When a communication system including communication apparatuses autonomously carries out the designation of the line and the request of setting of items described below, the controller of one of the communication apparatuses may conduct such operation. When the overall operation of the communication system is managed by an external device, the operation may be achieved by an external controller, not shown, linked with the management and control communication line.

Next, the diagnosis line is set to a test mode (step A2). The main signal transmission path is disconnected between the communication apparatuses 100 and 200, and the test signal multiplexer 114 and the test signal separator 115 are set up so that the main signal transmitter 111 is connected to the main signal receiver 112.

A bit rate of a test signal is then designated (step A3). In this situation, the test signal transmitter 116, the test signal receiver 117, and the CDR sections 113 on the transmitter and receiver sides are set up to operate at a predetermined bit rate. When each CDR section 113 includes a function to automatically establish synchronization with the operation speed or the bit rate of the input signal, it is not necessarily required to register the operation speed to each CDR section 113. The bit rate of the test signal is set to a value more than that of the bit rate of the signal used for ordinary communication.

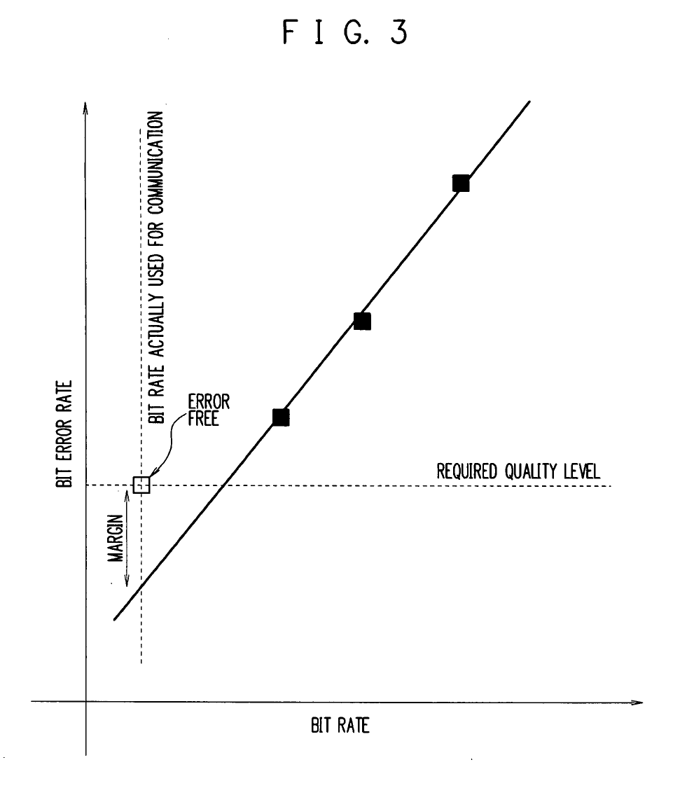

Thereafter, a bit error rate is measured (step A4). According to one of the methods of measuring the bit error rate, the test signal transmitter 116 produces pseudo-random patterns, repetitious pseudo-random patterns and the like. The test signal receiver 117 compares the received signal pattern with a normal pseudo-random pattern to obtain the number of error bits to thereby calculate a ratio between the error bits and the transmitted bits. Steps A3 and A4 are executed predetermined times along with a bit rate change of step A5 so that frequency-dependent data of the bit error rate is obtained in step A6. In step A6, the bit error rates are obtained for the respective bit rates and are added to each other to obtain the total thereof as a line diagnosis result shown in FIG. 3.

The result of FIG. 3 shows that a bit rate actually used for communication does not cause errors, and when the bit rate is increased for measurement, the bit error rate gradually increases. In this case, “error free for all measurements” does not hold in step A7 (no in step A7), and hence control goes to step A9. In this example, on the basis of the result of the bit error rate measured when the bit rate is increased, a margin of the bit rate that is actually adopted for communication is estimated.

If the result of measurement differs from that shown in FIG. 3, for example, if “error free for all measurement results” is satisfied, processing goes to step A8. In this situation, it is assumed that a sufficiently large margin exists for the bit rate, and the line diagnosis is finished.

Through step A8 or A9, processing goes to step A10 in which the test mode is released for the diagnosis line, and the setting for the connection of the main signal transmission path is completed.

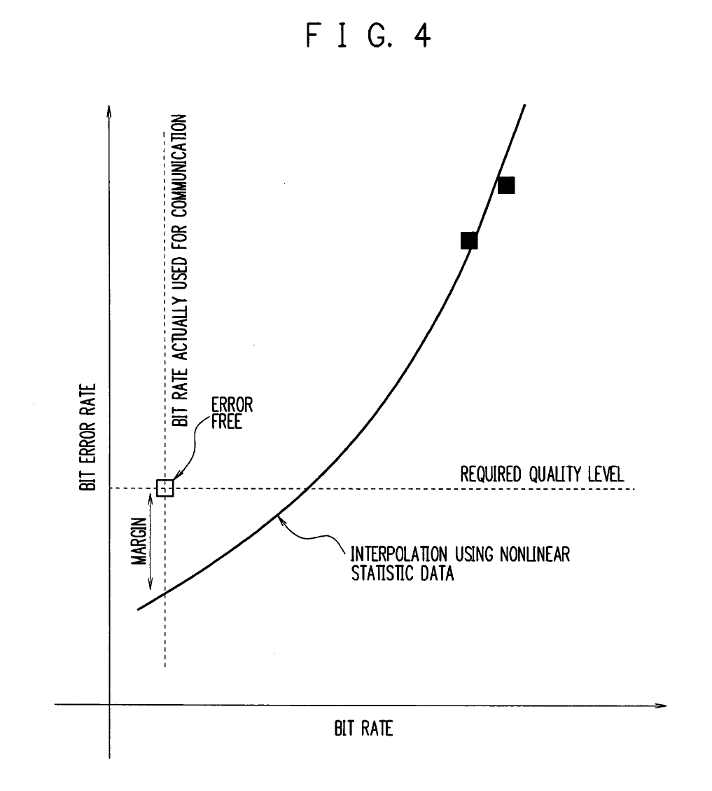

In step A9, there likely occurs a case wherein it is not possible to gather data sufficient to estimate the line quality for the bit rate actually employed for communication as shown in FIG. 3. To quantitatively estimate the line quality also in this situation, it is possible to utilize, as interpolation data, previously accumulated statistic data associated with the communication characteristic of the communication apparatus 100. For example, if there has been accumulated statistic data in which the bit error rate characteristic nonlinearly becomes worse as the bit rate of the communication line increases, the margin of the bit rate actually used for communication can be estimated by use of nonlinear interpolation data as shown in the line diagnosis result of FIG. 4.

By utilizing the line diagnosis method, there can be obtained advantages as follows. Since the bit error rate is measured at various operation speeds or bit rates higher than the line bit rate actually employed for communication, it is possible to determine the line quality at the bit rate used for the actual communication.

If the line quality is evaluated only for the bit rate actually used for communication or for bit rates less than that used for the actual communication, there is obtained a result of “error free” indicating that there exists no problem as the usual quality. However, quantitative quality information indicating a margin of the bit rate is not obtained. In accordance with the embodiment, the quantitative quality information can be obtained.

The test signal multiplexer 114, the test signal separator 115, and the CDR module 113 arranged between the main signal line in device and the main signal transmitter 111 or the main signal receiver 112 are not dependent on protocols and are configured to operate as a whole at a desired line bit rate. It is therefore possible to provide a communication apparatus capable of conducting a transparent operation independently of communication standards.

In the configuration, the communication between the communication apparatuses is carried out using the management and control lines, not the main signal transmission paths. Therefore, it is not required to send a new protocol for the test through the main signal transmission paths used to transfer the main signal, and hence there is not required any special circuit. This makes it possible to simplify the overall configuration of the main signal circuit.

Referring now to the drawings, description will be given of the second exemplary embodiment. A communication apparatus of the second exemplary embodiment is almost the same in the configuration as that of the first exemplary embodiment, but differs in the following points. The main signal transmission path functions as an optical fiber transmission path, the main signal transmitter 111 includes a function to convert electric signals into optical signals to produce optical signals, and the main signal receiver 112 includes a function to receive optical signals to convert the signals into electric signals.

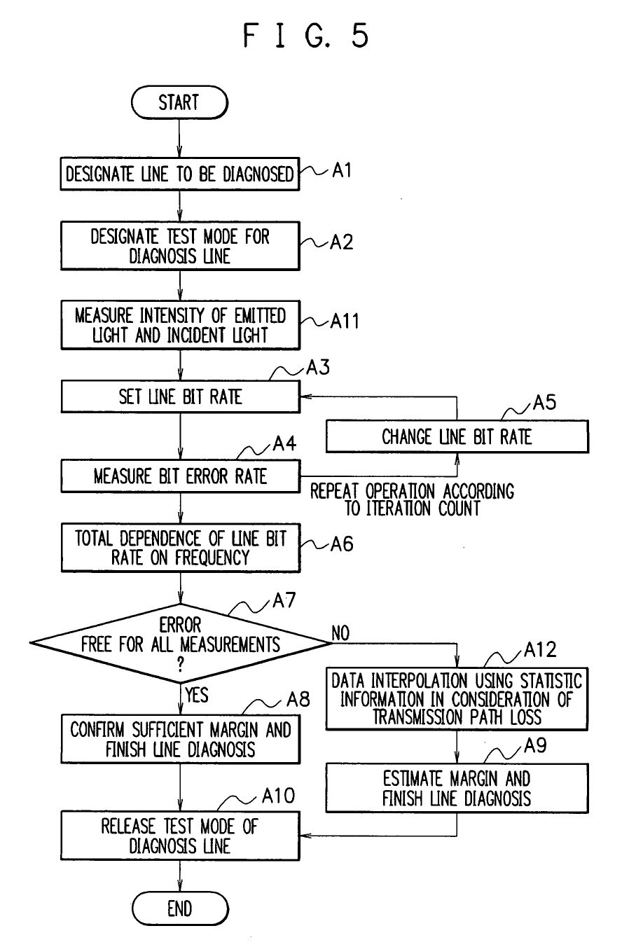

Description will be given of operation of the line diagnosis method by the communication apparatus 100. FIG. 5 shows the line diagnosis operation by the communication apparatus in a flowchart. This is different from the flowchart of FIG. 2 in that step A11 is disposed after step A2 and step A12 is arranged before step A9, the margin estimation step. In step A11, intensity of transmitted light and intensity of received light are measured. In step A12, data interpolation is carried out by use of statistic information according to a transmission path loss.

For measurement of the intensity of emitted light and intensity of incident light at step A11, no special evaluation device is needed but a monitor circuit mounted on an ordinary optical transceiver suffices for that purpose. Assume that the intensity measurement is accomplished under a condition that the emitted light has been modulated using appropriate data or an appropriate test signal. If the mark ratio is fixed, the intensity of the emitted light thus modulated takes a constant value regardless of the bit rate. Therefore, step A11 may be placed at any position as long as before step A12, which uses measured data.

Description will be given in detail of step A12 disposed for the following purpose: information of the main signal transmission path such as information of the transmission path loss, used as the statistic information associated with the dependence of the bit error rate on the bit rate, is also employed to obtain interpolation data with higher precision. Since power of transmitted light and intensity of incident light on a target communication line have been beforehand measured, the loss on the main signal transmission path is obtained. If the loss is not excessive, the distance of the transmission path can be determined on the basis of the transmission path loss. It is therefore possible to consider influences of, for example, the wavelength dispersion associated with the transmission path length.

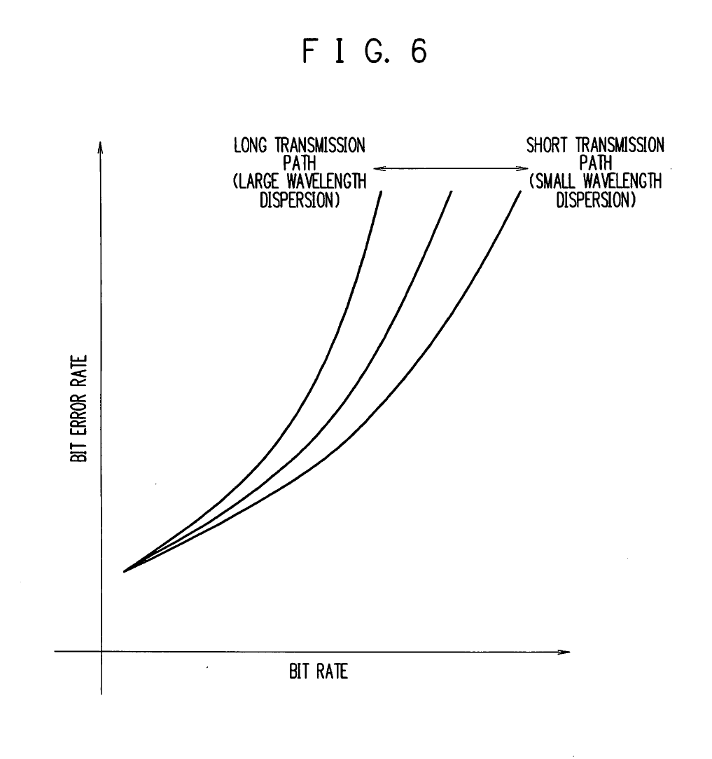

FIG. 6 conceptually shows the dependency of the bit error rate on the bit rate under different transmission distances (different amounts of wavelength dispersion) when the transmission path is a single-mode fiber, and the transmission signal has a wavelength in the 1.55 micrometer band, which may be regarded as an ordinary long-distance optical communication system. When the line bit rate increases, the intensity of light per bit lowers and the bit error rate increases. However, if there exists the influence of the wavelength dispersion, the signal is remarkably deteriorated for a high bit rate, and the increase in the bit rate error tend to become higher. Therefore, to determine the margin in step A9 of FIG. 5, if the transmission path length is known, the margin can be estimated with higher precision.

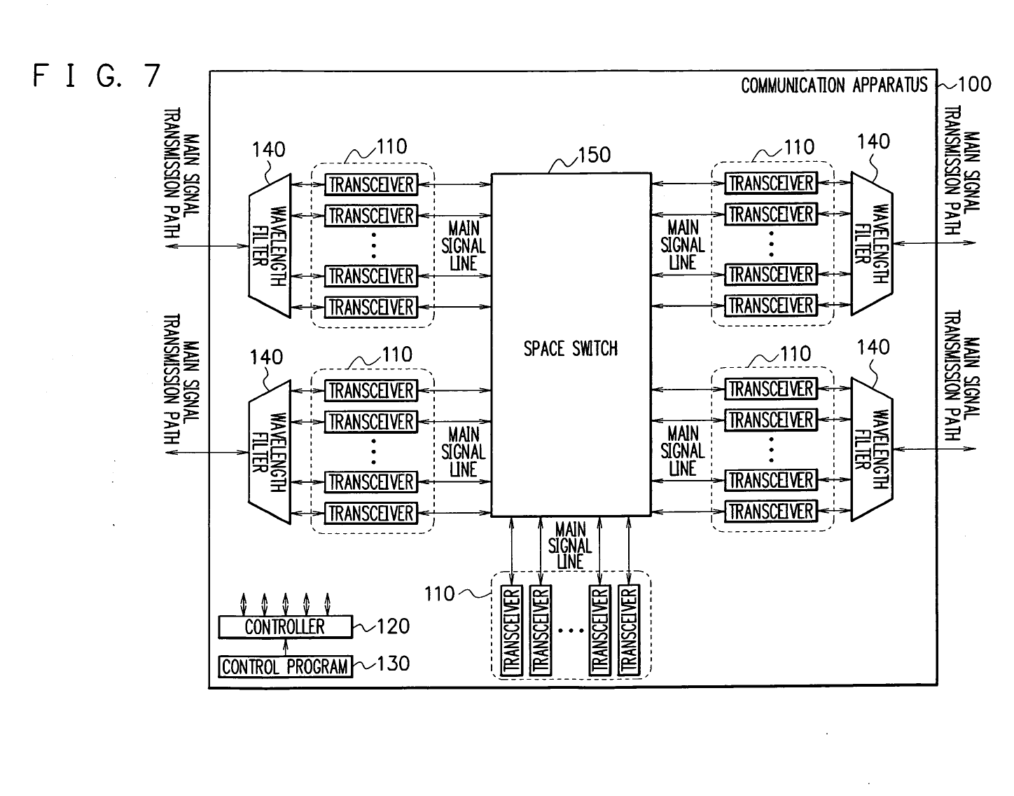

Next, description will be given of the line diagnosis method in a specific configuration of the communication apparatus. FIG. 7 shows, in a block diagram, structure of the communication apparatus 100 in which transceivers 110 are arranged.

The communication apparatus 100 of FIG. 7 is independent of protocols and is configured according to a wavelength division multiplexing scheme to transmit signals using a desired wavelength channel. The transceiver section thereof linked with the main signal transmission path includes the transceivers 110. Each transceiver 110 includes an optical transceiver unit that operates as a Wavelength Division Multiplexing (WDM) transceiver on a designated wavelength channel.

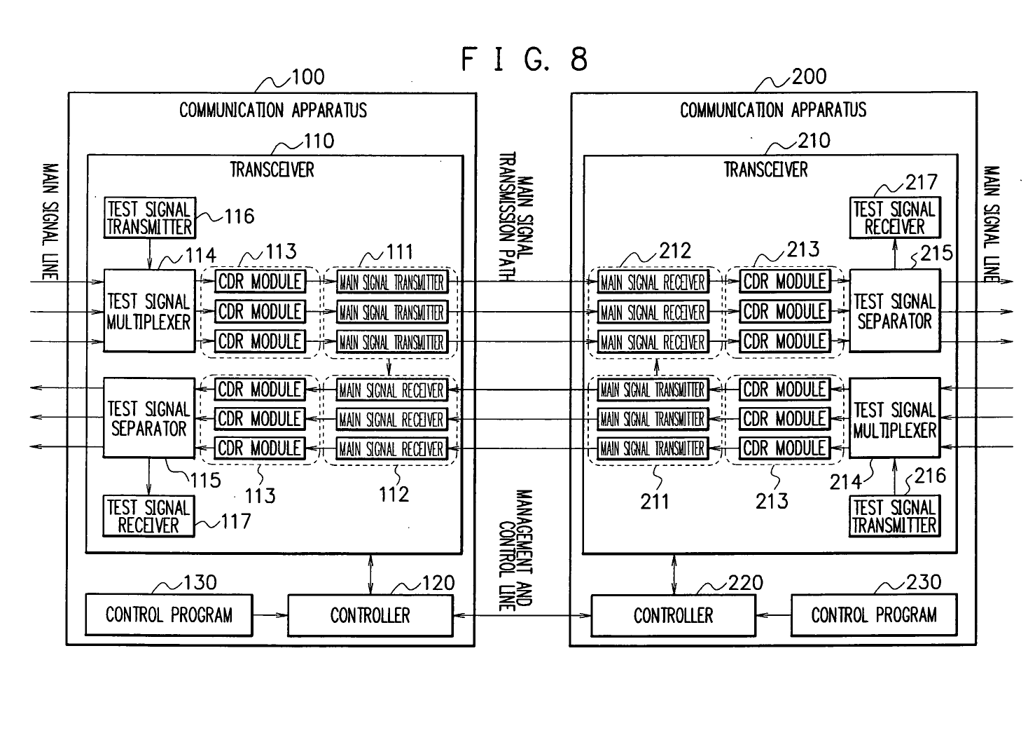

As in this specific example, if the communication apparatus 100 includes transceivers 110, the circuit of each transceiver may be configured such that the test signal transmitter 116 and the test signal receiver 117 are shared among main signal lines as shown in FIG. 8. However, it is assumed in this situation that the test signal multiplexer 114 is capable of feeding a test signal to a desired main signal line, and the test signal can be transferred from a desired main signal line to the test signal separator 115. Also, when the test signal multiplexer 114 and the test signal separator 115 are operated, the operation does not cause a bit error on the other main signal lines to which the test signal is not delivered. The input and output signals of each optical transceiver unit are multiplexed or demultiplexed by a wavelength filter 140 to be coupled with an optical fiber (a main signal transmission path).

The main signal lines of the transceiver 110 are linked with a space switch 150. The switch 150 is connected to a transceiver 110 for different wavelengths coupled with the same main signal transmission path, a transceiver 110 coupled with a different main signal transmission path, and a transceiver 110 linked with a service line. That is, it is possible to set up the system so that these components are freely connected to each other as above.

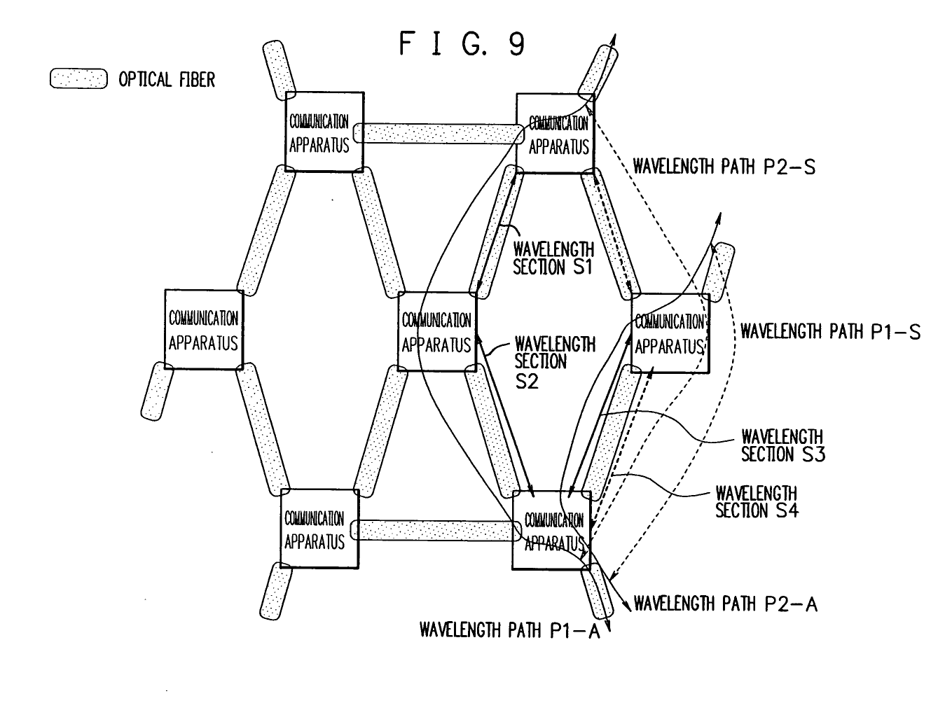

The communication apparatus 100 has transparency, i.e., is not protocol-dependent and has high connectibility of wavelength cross connect and fiber cross connect. Therefore, in the optical network system as shown in FIG. 9, the communication apparatus 100 is effectively applicable to a mesh network having efficient redundancy. Examples of redundancy of the wavelength path are as follows: a wavelength section is redundantly configured in one optical fiber and redundancy is provided for the wavelength path (P2-A and P2-S of FIG. 9); and redundancy is provided for the overall wavelength path by use of a different fiber (P1-A and P1-S of FIG. 9). Both cases are applied on the basis of a rule that a wavelength section allocated to a standby system is not used by any currently working system, or a wavelength section allocated to a standby system may be allocated with low priority to another communication line. However, in the example of FIG. 9, a wavelength section S4 is commonly allocated to P1-S and P2-S that are standby systems for the wavelength paths P1-A and P2-A respectively, to thereby efficiently configure the standby systems. In the configuration, unless failure occurs in P1 and P2 at the same time, the wavelength section S4 functions as a common or shared section in the paths respectively assigned as standby systems.

An actual mesh system includes many wavelength sections such as a wavelength section S4. However, the current communication line is not ordinarily allocated thereto, and hence there does not exist a way to obtain information in the ordinary state whether or not signals appropriately travel or whether or not the appropriate line quality is retained without deterioration in transmission paths and transceivers. Moreover, in an emergency, the system needs securely carry out the operation. For the improvement of reliability of the overall system, it is quite important to conduct the line quality diagnosis regularly to recognize the line quality for the standby communication line that is rarely operated but required to operate without fail. For this kind of system, the line diagnosis method is effectively applicable.

### Third Exemplary Embodiment

The communication apparatus may further include a communication line to communicate control signals for a line diagnosis with a second communication apparatus opposing to the communication apparatus.

### Fourth Exemplary Embodiment

In addition, the signal employed for communication may be converted into an optical signal to be sent to the second communication apparatus and an optical signal received from the second communication apparatus may be converted into an electric signal.

As set forth above, the communication apparatus in accordance with the invention is designed so that the apparatus communicates signals at a bit rate higher than that of signals employed for communication. It is possible to collect sample data required for the line diagnosis by intentionally lowering quality of the communication line by use of a test signal having a higher bit rate. This resultantly leads to higher precision in the line diagnosis.

When a dedicated line is disposed for the communication apparatus to communicate control signals for the line diagnosis with a second communication apparatus on the dedicated line, it is not required for the communication apparatus to issue a new protocol for the test signal onto the communication line. As a result, the constituent components of the system using the communication line are independent of protocols. This leads to simplification of the system and for example, modification in the design of such components are not required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication apparatus, comprising a generator that generates a test signal to be used for a line diagnosis,
wherein the apparatus conducts a line diagnosis with the test signal having a bit rate more than a bit rate of a signal for communication.

2. The communication apparatus in accordance with claim 1, further comprising a communication line to communicate control signals for a line diagnosis with a second communication apparatus opposing to the communication apparatus.

3. The communication apparatus in accordance with claim 1, wherein the signal employed for communication is converted into an optical signal to be sent to the second communication apparatus and an optical signal received from the second communication apparatus is converted into an electric signal.

4. A line diagnosis method of conducting a line diagnosis, wherein a test signal for a line diagnosis has a bit rate more than a bit rate of a signal for communication.

5. A computer program product for use with a communication apparatus, the program causing a computer to perform:
generating a test signal to be used for a line diagnosis; and
conducting a line diagnosis with the test signal having a bit rate more than a bit rate of a signal for communication.

6. A recording medium having recorded therein the program in accordance with claim 5.

7. A communication apparatus, comprising means for generating a test signal to be used for a line diagnosis,
wherein the apparatus conducts a line diagnosis with the test signal having a bit rate more than a bit rate of a signal for communication.
